(19) United States
(12) Patent Application Publication
(10) Pub. No.: US 2014/0265143 A1
(43) Pub. Date: Sep. 18, 2014

(54) MECHANICAL SEAL SUPPORT SYSTEM

(71) Applicant: Thomas Broadbent, Glossop (GB)

(72) Inventor: Thomas Broadbent, Glossop (GB)

(73) Assignee: AES ENGINEERING LTD.

(21) Appl. No.: 14/205,609

(22) Filed: Mar. 12, 2014

(30) Foreign Application Priority Data
Mar. 12, 2013 (GB) 1304435.9

(51) Int. Cl. F16J 15/16

(52) U.S. Cl. CPC F16J 15/162
USPC 277/390

(57) ABSTRACT

A mechanical seal support system includes a pre-pressurized bladder accumulator containing a barrier fluid and a gas under pressure. A cooling circuit includes a mechanical seal for feeding the barrier fluid from the accumulator to the cooling circuit with a pressure regulating device located between the accumulator and the cooling device. A device, responsive to the pressure in the cooling circuit, for indicating when an actual pressure is below a predetermined pressure level is included.

### BACKGROUND OF THE INVENTION

1. Technical Field of the Invention

The invention relates, generally, to mechanical seal support systems and, more particularly, to a method for maintaining constant barrier fluid pressure in a mechanical seal loop.

2. Description of the Prior Art

An API Plan 53B seal support system is a pressurized barrier fluid circulation system in an outboard seal of dual seal configuration. Circulation is maintained by using pumping ring in running condition. The pressure is maintained in the seal circuit by a bladder accumulator.

In an API Plan 53B seal support system barrier fluid is stored and the pressure is maintained through the use of a pre-pressurized bladder-type accumulator. The barrier fluid is not circulated through the bladder accumulator but around a cooling loop, which will include a separate heat exchanger. The accumulator is effectively on a dead leg and its sole purpose is to store fluid and pressure. It does not play any part in cooling the barrier fluid. Flow is maintained by an internal pumping ring within the seal. The pressure will vary depending on the level of the liquid in the reservoir, and a pressure switch is used to alarm for a low liquid level based upon pressure in the system. Volume of fluid in a bladder accumulator cannot be directly measured.

API Plan 53B systems, with their trapped gas volume, are very susceptible to changes in ambient temperature. Where there are large diurnal and seasonal changes in ambient temperature, barrier fluid pressure will correspondingly be affected. If ambient temperature conditions are not taken into consideration when designing the alarm strategy, in extremely hot ambient conditions, it may be possible that the accumulator becomes completely depleted of liquid without triggering the pressure alarm. On extremely cold nights pressure alarm may be activated when there is still sufficient liquid remaining in the accumulator. The operator will then refill the barrier fluid, causing excessive fluid volumes in the accumulator, which may over pressurize the system if the temperature rises the following day. Solar radiation can amplify this problem. Software can provide the user with a proposed alarm strategy, however adopting this may force users to specify unnecessarily high barrier fluid pressure. This will cause unnecessary wear and stresses on the seal faces and may limit operators in the use of back-to-back dual seals, which have compromised reliability on contaminated services. Another proposed strategy, which is included in the Draft International Standard for the 4^{th} revision of API 682 ISO 21049, will propose that the simple pressure switch is replaced by a pressure and a temperature transmitter. Taking both readings and using simple logic of a distributed control system (DCS) the actual liquid level is thus calculated.

### SUMMARY OF THE INVENTION

According to the present invention, the issues relating to variable pressures in the system produced by varying ambient temperatures and depleting levels of barrier fluid are overcome with the use of a pressure regulation device between the system and the mechanical seal loop. Located on the seal feed line the pressure regulation device creates a constant pressure area in the mechanical seal loop and a variable pressure area in the system. The system may comprise in one embodiment:

(a) An API Plan 53B system;

(b) A pressure regulating device;

(c) A mechanical seal with cooling loop;

(d) Control mechanisms in the constant pressure area to highlight when the pressure has decreased and so the barrier fluid level has diminished.

Preferably, the pressure regulation device is of modular design so that it can be fitted to a standard pressurized barrier fluid circulation system, for example an API Plan 53B system.

Preferably, the pressure regulation device is set prior to installation onto the system.

Preferably, the pressure regulation device is self-relieving so that any unsafe increases in pressure do not become dangerous.

Preferably, the pressure regulation device can be isolated via ball valves located on its inlet and outlet.

Preferably, the control mechanisms comprise a pressure and temperature transmitter located in the constant pressure area to highlight when the barrier fluid level has depleted to an undesirable level.

Other objects and features of the present invention will become apparent when considered in combination with the accompanying drawing figure, which illustrates a preferred embodiment of the present invention. It should, however, be noted that the accompanying drawing figure is intended to illustrate only a select preferred embodiment of the claimed invention and is not intended as a means for defining the limits and scope of the invention.

### BRIEF DESCRIPTION OF THE DRAWING FIGURE

FIG. 1 shows a schematic diagram of the present invention with relation to a pressurized barrier fluid circulation system configuration and mechanical seal.

### DETAILED DESCRIPTION OF THE DRAWING FIGURE AND PREFERRED EMBODIMENT

With reference to the accompanying drawing figure, a pressurized barrier fluid circulation system is schematically shown in the form of an API plan 53B system 1, which comprises a bladder accumulator 2, which has its bladder pre-charged with nitrogen to a specified percentage above the maximum product pressure. Included in the system are various ball valves and piping paths for venting 3, draining 4 and filling 5 the system. The number and type of ball valves depends on customer and application stipulation. Once the bladder is pre-charged, the system is filled with barrier fluid with the fill 5 and vent 3 ball valves in open configurations. The check valve 6 ensures that back flow does not occur. The system is filled to a pre-determined pressure specific to the application. Various pressure indicators and transmitters 7 are located in the system lines so that the pressures can be viewed and the system is correctly set.

A flange fixture 8 is located on the line to the seal loop 9 allowing further piping to be connected. In the invention, a pressure regulation device 10 is fitted at this location between ball valves 11, which allow isolation of the system 1, pressure regulator 10 and the seal loop 9 to be achieved, if required. An example of a suitable pressure regulation device is a Go Regulator PR-1 Series Adjustable Pressure Reducing Regulator. The location of the pressure regulation device 10 means that, as pressure fluctuates in the system 1 due to changes in temperature conditions, a constant pressure is maintained in the seal loop 9 after it. Depending on the application, it may be preferable for other various instrumentation or fixtures and fittings to be incorporated into the system before or after the pressure regulation device 10.

Should the pressure in the seal loop 9 increase to a greater level than in the system arrangement 1, the pressure regulation device 10 will preferably allow relief of the pressure, either in the counter direction to normal operation or to the atmosphere.

While only several embodiments of the present invention have been shown and described, it will be obvious to those skilled in the art that many modifications may be made to the present invention without departing from the spirit and scope thereof

What is claimed is:

1. A mechanical seal support system, comprising:
a pre-pressurized bladder accumulator containing a barrier fluid and a gas under pressure;
a cooling circuit including a mechanical seal for feeding the barrier fluid from said pre-pressurized bladder accumulator to said cooling circuit;
a pressure regulating device located said pre-pressurized bladder accumulator and said cooling circuit; and,
means for indicating when an actual pressure level in said cooling circuit is below a predetermined pressure level.

2. The mechanical seal support system according to claim 1, wherein said pressure regulating device has a modular construction.

3. The mechanical seal support system according to claim 1, wherein said pressure regulating device is capable of self-regulation.

4. The mechanical seal support system according to claim 1, wherein said pressure regulating device includes ball valves an inlet of said pressure regulating device.

5. The mechanical seal support system according to claim 1, wherein said pressure regulating device includes ball valves an outlet of said pressure regulating device.

6. The mechanical seal support system according to claim 1, further comprising a pressure and temperature transmitter located adjacent said pressure regulation device.
